(19) United States
(12) Patent Application Publication
(10) Pub. No.: US 2014/0056587 A1
(43) Pub. Date: Feb. 27, 2014

(54) ELECTRO/OPTICAL PLUG-AND-SOCKET CONNECTION, ESPECIALLY ELECTROOPTICAL USB PLUG-AND-SOCKET CONECTION

(71) Applicants: Wojciech Piotr Giziewicz, Regensburg (DE); Thomas Albert Hall, San Jose, CA (US); Hank Daniel Ching, Fremont, CA (US)

(72) Inventors: Wojciech Piotr Giziewicz, Regensburg (DE); Thomas Albert Hall, San Jose, CA (US); Hank Daniel Ching, Fremont, CA (US)

(73) Assignee: Amphenol Tuchel Electronics GmbH, Helbronn (DE)

(21) Appl. No.: 13/822,376

(22) PCT Filed: Sep. 12, 2011
(86) PCT No.: PCT/EP2011/004580

§ 371 Date: Oct. 31, 2013

(30) Foreign Application Priority Data
Sep. 12, 2010 (DE) 102010044834.6

(51) Int. Cl. G06F 13/38; H04B 10/27

(52) U.S. Cl. CPC G06F 13/387; H04B 10/271
USPC 398/117

(57) ABSTRACT

The invention relates to a plug-and-socket connection for connection of a first apparatus via a cable which contains electrical connections and optical connections to a second apparatus or a device, the first apparatus having an apparatus socket and the device having a device socket for accommodating the plug of the cable, characterized in that the apparatus socket and also the device socket having means to convert preferably a part of the electrical signals which were applied on the input side to the apparatus socket into optical signals when a controller/transceiver which is provided in the apparatus socket ascertains that the connected cable has optical lines and that the device socket or apparatus socket is made for receiving optical and electrical signals.

In general the invention relates to an electrooptical apparatus plug-and-socket connection between several, for example two apparatus, an electrooptical plug-and-socket connection between one apparatus and an electrooptical cable (hybrid cable), an electrooptical socket and an electrooptical plug. Preferably the invention relates to a USB 3.5 socket, especially for installation in an apparatus, for example the first and second apparatus.

The electrooptical socket as claimed in the invention, especially the USB 3.5 socket as claimed in the invention, allows data transmission by means of electrical signals, but is also able, when the corresponding conditions are present, to transmit optical data signals in order in this way to achieve for example a higher data transmission speed.

Plug-in connectors are already known which work according to USB 3.0 regulations and which can interoperate with plug-in connectors according to the USB 2.0 standard. These plug-in connectors according to USB 3.0 regulations are therefore downward-compatible, i.e. to a USB 2.0 plug-in connector. The object of the invention is to provide an electrooptical plug-in connector, especially a USB plug-and-socket connection which allows data transmission by means of electrical and/or optical signals.

As claimed in the invention the following are provided: a plug-and-socket connection for connection of a first apparatus via a cable which contains electrical connections and optical connections to a second apparatus or a device, the first apparatus having an apparatus socket and the device having a device or apparatus socket for accommodating the plug of the cable, characterized in that the apparatus socket and also the device socket having means to convert preferably a part of the electrical signals which were applied on the input side to the apparatus socket into optical signals when a controller/transceiver ascertains that the connected cable has optical lines and that the device socket or apparatus socket is made for receiving optical and electrical signals.

The USB3 socket made as claimed in the invention is called a USB 3.x socket here which in addition to data transmission by means of electrical signals according to USB 2.0 and USB 3.0 regulations also allows data transmission by means of optical signals.

As claimed in the invention the USB 3.x socket which can be installed in a (first) apparatus, for example a computer, has means for converting electrical signals which have been applied to the USB 3.x socket into optical signals and for making available the optical signals at the corresponding outputs of the USB 3.x socket for relay.

Preferably the conversion means have means which ascertain whether the prerequisites necessary for transmission of optical signals are satisfied, i.e. whether for example a cable which transmits optical signals is connected and whether it is also connected to a (second) apparatus which is suitable for receiving optical signals.

In particular the invention calls for a miniaturized optoelectronic transceiver which is installed in the USB 3.x socket and which can be connected to an apparatus-typical circuit of the (first or second) apparatus in which the USB 3.x socket has been installed.

As claimed in the invention a controller/transceiver is installed in the USB 3.x socket. The transceiver has driver and receiving ICs with intelligence. The transceivers detect whether a USB 3.x cable is connected to the socket, and likewise with a corresponding USB 3.x socket on the other end of an optical USB 3.x cable.

The means provided as claimed in the invention in the USB 3.x socket of the first apparatus, especially controller and transceiver operational equipment of the controller transceiver, ascertain whether there are both a USB 3.x cable, therefore also a USB 3.x socket (hybrid socket) in the second apparatus on the other end of the cable and cause optical data transmission.

The USB 3.x socket as claimed in the invention therefore also has the description “link aware” transceiver, i.e. a transceiver which can ascertain whether the prerequisites for an optical connection are present.

Other advantages, objectives, and details of the invention will become apparent from the description of exemplary embodiments using the drawings.

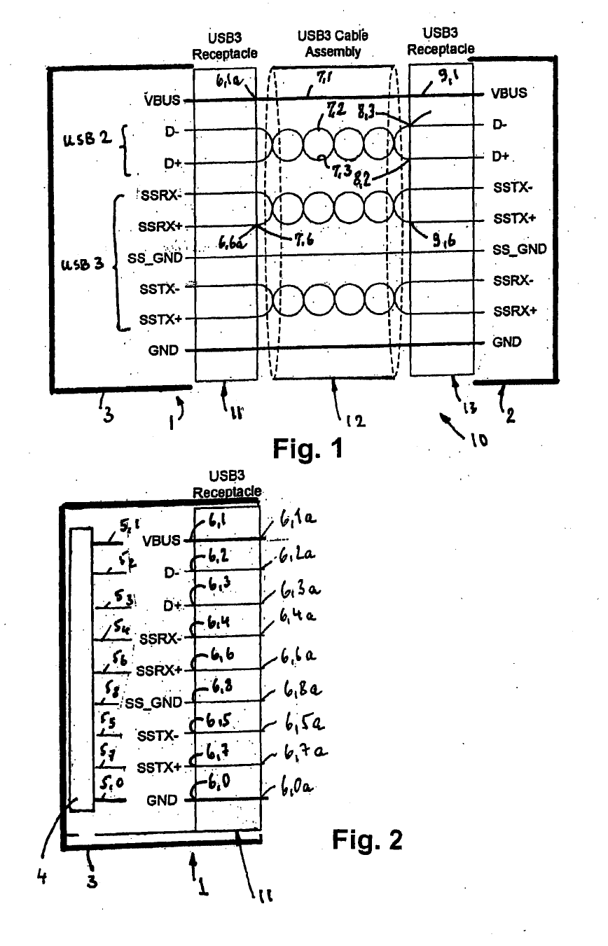

FIG. 1 shows a schematic of two USB 3.0 sockets, installed in two apparatus, which are connected by a USB 3.0 cable arrangement;

FIG. 2 shows a detail of the USB 3.0 socket of FIG. 1;

FIG. 3 schematically shows the structure of an apparatus plug-and-socket connection as claimed in the invention between a first apparatus and a second apparatus via an optical hybrid cable;

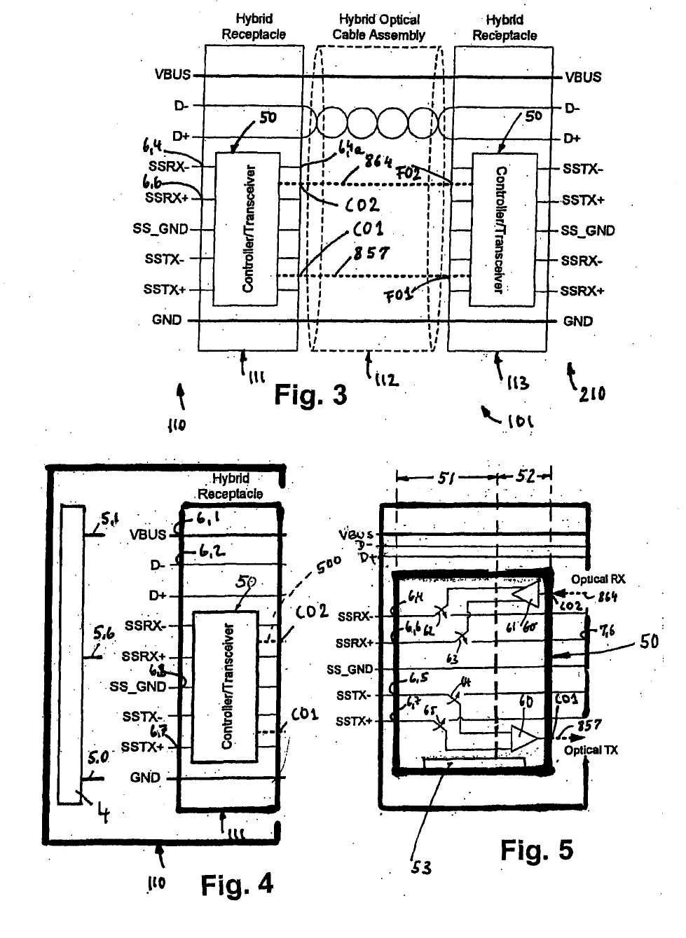

FIG. 4 shows a hybrid computer socket or USB 3 socket installed in a first apparatus with means as claimed in the invention for making available optical signals for ascertaining whether there is a transmission possibility for optical signals;

FIG. 5 shows details of the means for alternative transmission of electrical or optical signals, especially depending on the transmission possibilities;

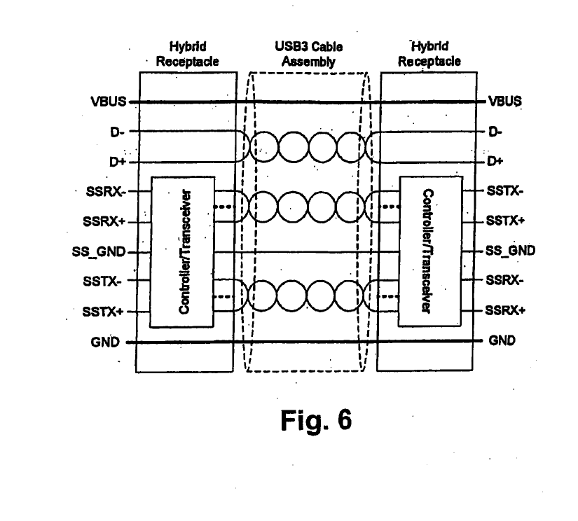

FIG. 6 shows the connection between two USB 3.x sockets in which optical signal transmission is not possible in sequence of the USB 3.0 cable;

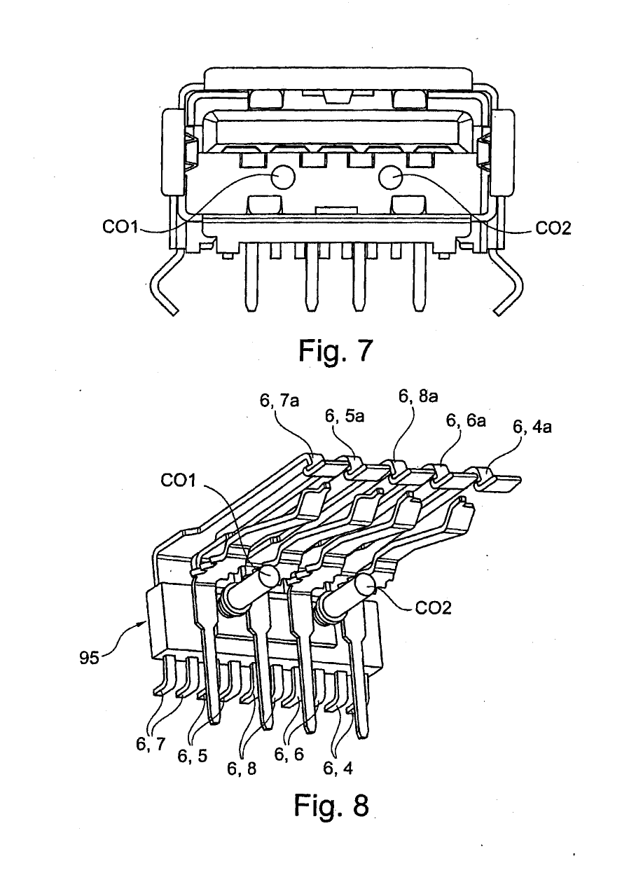

FIG. 7 shows a front view of the socket according to FIG. 8;

FIG. 8 shows a perspective view of a socket which can be installed in an apparatus from the output side.

FIG. 1 is a schematic of a known plug-and-socket connection (apparatus plug-and-socket connection) 10 using a cable 12 which has conductors 7.1, 7.2, 7.3, . . . between a first apparatus 1 (for example a computer; hereinafter reference is made to the first apparatus as a computer 1) and a second apparatus 2 (for example a hard disk; hereinafter reference is made to the second apparatus using the term hard disk 2). The second apparatus is also called a receiving apparatus or device 2.

The apparatus plug-and-socket connection 10 has the following: a socket 11 which has several inputs 1; 8.2; 8.3; . . . , preferably a USB 3 socket (hereinafter reference being made to the socket 1 with the term computer socket 1) and another USB 3 socket 13 (to which reference will be made in the following as a hard disk socket 13), between the two sockets 11 and 13 the cable 12, for example a USB 3 cable (USB3 cable assembly) 12, producing the electrical connection, i.e. the electrical transmission paths.

The invention is described below especially with reference to the computer socket 11, but analogous statements also applying to the hard disk socket 13.

Let it be pointed out that the description uses terms like “on the input side” and “on the output side” as well as “input” or “output” as if information transmission takes place always from a computer circuit 4 which is present in the computer 1 only to a hard disk circuit which is present in the hard disk 10. The computer circuit 4 has output terminals 5.0-5.8. Of course information transmission can also take place in the reverse direction, as is the case for example in an optoelectrical converter 61 of FIG. 5.

The computer socket 11 has, compare FIG. 2, numerous input terminals 6.0 to 6.8 which are connected to the corresponding output terminals 6.0a to 6.8a of the computer socket 11. The input terminals 6.0 to 6.8 are connected to the corresponding output terminals 5.0 to 5.8 of the electrical computer circuit 4. Reference is also made below to this electrical circuit as computer electronics 4. In the case of a USB 3.0 computer socket the input terminals 6.2 and 6.3 to the D− and D+ connection of a USB 2.0 socket can be present, the corresponding output terminals 6.2a and 6.3a of the computer socket 11 being connected to the two conductors or conductor terminals 7.2 and 7.3 of the cable 12 in order to establish the connection to the input terminals 8.3 and 8.2. The input terminals 8.2 and 8.3 have corresponding output terminals D+ and D−.

Similarly, compare FIG. 1, the USB 3 connection is established by the input terminals 6.4 to 6.8 of the computer socket 11, the SSTX− connection and the SSTX+ connection being assigned to the terminals 6.5 and 6.7 which are then connected to the corresponding two conductors of the cable 12 and to the corresponding terminals 9.5 and 9.7 of the hard disk socket 13 via the wire connection of the cable 12. The just described connection path is one connection path of the USB 3 connection, while the other connection path of the USB connection is the connection path which is located above it in FIG. 1, of which the computer socket terminal 6.6, the conductor terminal 7.6 and the hard disk socket terminal 9.6 are shown.

At this point the invention is described using FIGS. 3 to 5 and 7 and 6. FIG. 6 constitutes a case in which together with the sockets as claimed in the invention a cable which is not made as claimed in the invention is used.

FIG. 3 shows a hybrid socket 111 which is assigned to the first apparatus (for example a computer) 1 and which is made in the manner as claimed in the invention. Reference is also made to the hybrid socket 111 of the first apparatus 1 as a computer socket or hybrid computer socket or also a hybrid apparatus socket 111 and a hybrid socket 113 of the second apparatus or of the device 2 is called a hard disk socket, hybrid hard disk socket or hybrid device socket 113. A special cable 112 which can also be called a “hybrid optical cable assembly” connects the computer socket 111 (which can also be called the hybrid receptacle 111) to the hard disk socket 113 (which can also be called the hybrid receptacle). The cable 112 in addition to the wires which are characteristic for USB 2 has another two optical conductors 864 and 857 which replace the electrical wires of the cable 12 of the first and second USB3 connections.

The hybrid computer socket 111 in addition to the USB2 connection alternately establishes a USB3 connection by corresponding wires of the cable 112 in the manner illustrated in FIG. 1 or, compare FIG. 3, via the optical connections or conductors 864 and 857.

To enable this, both the hybrid computer socket 111 and also the hybrid hard disk socket 113 are equipped with a controller/transceiver, i.e. a control device/transmitting and receiving device 50.

In turn referencing only the hybrid computer socket 111, the structure of the hybrid computer socket 111 will be explained with reference to FIGS. 4 and 5.

On the input side the hybrid computer socket 111 (FIG. 3) is made in the same manner as the conventional USB3 computer socket 11. On the output side the hybrid computer socket 111 is additionally provided with two optical outputs CO1 and CO2. The hybrid computer socket 111 can therefore continue to electrically transmit alternately the electrical signals supplied via the input terminals 6.4 to 6.7 via electrical conductors when there are no optical lines 857 and 864 in the cable 12 and moreover no hybrid hard disk socket 113 on the side of the hard disk 2.

As claimed in the invention the hybrid computer socket 111 (and of course also the hybrid hard disk socket 113) is equipped with a controller/transceiver 50 which is shown in particular in FIG. 5. The controller transceiver 50 has a controller segment 51 and a transceiver segment 52 and furthermore controller and transceiver operational equipment 53. Reference is also made to these components as converter means.

The transceiver segment 52 has especially two electrooptical converters 60, 61, specifically an electrooptical converter 60 and an optical-electrical converter 61. The electrooptical converter 60 can convert electrical signals at its input into optical signals and deliver them to the output CO1. The optical-electrical converter 61 on the input side picks up optical signals which have been applied to the terminal CO2 and converts them, if desired, into electrical signals. The electrical signals are then delivered via switches 62, 63 to the terminals 6.4, 6.6.

The electrical signals on the input terminals 6.5, 6.7 are then connected to the electrooptical converter 60 when the switches 64 and 65 are in the optical transmission position shown. Accordingly the electrical output signals of the optical/electrical converter 61 are also connected to the terminals 6.4 and 6.6 in the position of the switches 63, 64 which is the optical transmission position.

The controller and transceiver operational equipment 53 contain all hardware and software components to carry out the necessary transceiver and controller operations.

For example, the controller and transceiver operational equipment 53 can be outfitted with a “link-aware chip” which switches between the electrical and optical connection.

The transceivers 50 used in the transceiver segment 52 can have a driver and receiver IC with some intelligence. The transceivers 50 themselves can detect whether an optical USB cable 112 is available, and together with the hybrid hard disk socket 113 on the other end. If this is the case, the USB3 transmission is carried out optically, while otherwise the IC is used as a repeater of the electrical USB signal. This function also provides some advantages, compared to the simple passive USB 2, 3 sockets.

It is important that the transceiver 50 ascertains whether an optical USB cable 112 as well as a hybrid socket are present on the other end.

It is also possible that the control segment 51 in FIG. 5 is able by the means represented [by] the control and transceiver operational equipment 53 to determine which cable connection is present and depending on either routing the electrical signal in a standard USB cable to the electrical terminals or pins or to the internal optoelectronic transceiver which is represented here by the electrooptical converters 60 and optical/electrical converters 61.

FIGS. 7 and 8 show the mechanical structure of a socket 11, 13 as claimed in the invention which can be used both as a computer socket 11 and also a hard disk socket 13.

There are five output terminals 6.4a, 6.6a, 6.8a, 6.5a, 6.7a of corresponding contact arms ending in input terminals 6.4, 6.6, 6.8, 6.5, 6.7 respectively in order to be connected to the apparatus-typical circuit, here for example the computer circuit 4.

The controller/receiver 50 in FIG. 8 is housed in the insulating body 95.

### REFERENCE NUMBER LIST

1 first apparatus, for example computer
2 second apparatus, device, receiving apparatus, for example hard disk
housing
4 apparatus-typical circuit, for example computer circuit
5 outputs, output contact, electrical output contacts
6.0-6.8 input terminals of the socket 11
6.0a-6.8a output terminals of the socket 11
7.1; 7.2; 7.6 conductor terminal
8.1; 8.2; 8.3 inputs of the socket 13
9.1; 9.2; . . . hard disk input terminals
10 plug-and-socket connection or apparatus plug-and-socket connection, for example USB3 plug-and-socket connection
11 socket, for example USB3 socket, for example computer socket
12 cable, for example USB3 cable
12A cable, for example USB3.5 cable
13 socket, device socket, hard disk socket, for example USB3 socket
13A socket, device socket, hard disk socket, for example USB3A socket
50 controller/transceiver (control device/transmitting and receiving device
51 controller segment
52 transceiver segment
53 controller and transceiver operational equipment
60 electrooptical converter
61 optical-electrical converter
62-65 switch
95 . . . body
101 optical/electrical plug-and-socket connection
110 computer
111 hybrid socket, hybrid apparatus socket, computer socket
112 cable
113 hybrid socket, hybrid device socket, hard disk socket, hard disk, optical conductor, optical conductor

1. A plug-and-socket connection for connection of a first apparatus via a cable which contains electrical connections and optical connections to a second apparatus or a device, the first apparatus having an apparatus socket and the device having a device socket for accommodating the plug of the cable, characterized in that the apparatus socket and also the device socket have means to convert preferably a part of the electrical signals which were applied on the input side to the apparatus socket into optical signals when a controller/transceiver which is provided in the apparatus socket ascertains that the connected cable has optical lines, and that the device socket is made for receiving optical and electrical signals.

2. The plug-and-socket connection as claimed in claim 1, wherein there is controller/transceiver operational equipment being provided which have a “link-aware” chip in the apparatus socket and the device socket in order to switch between electrical and optical transmission.

3. The plug-and-socket connection as claimed in claim 1, wherein the electrical signals applied to the apparatus socket are USB 3 signals, the apparatus socket being able to convert the electrical USB 3 signals into optical USB 3 signals, the optical USB 3 signals transmitted by the cable being convertible by the device socket into electrical USB 3 signals for use in the device.

4. A modified USB apparatus plug-in connector, especially a hybrid socket with one terminal side to the terminal of an apparatus and with one connection side for connection to a cable which allows optical and/or electrical signal transmission and which is connected to a USB terminal of a receiving apparatus, electrical apparatus signals which have been supplied by the apparatus and which are called electrical USB signals being convertible in the apparatus plug-in connector into optical USB signals when the connected cable is a cable which allows optical USB 3 signal transmission, and the receiving apparatus being designed itself or preferably by using a hybrid socket likewise for receiving optical USB 3 signals.

5. The modified USB apparatus plug-in connector as claimed in claim 4, in the hybrid socket converter means being contained which when optical USB 3 signals are applied by the apparatus, convert them into electrical USB 3 signals and apply them to the cable.

6. The modified USB apparatus plug-in connector as claimed in claim 4, in the hybrid socket converter means being contained which when optical USB 3 signals are applied by the cable, convert them into electrical USB 3 signals and apply them to the receiving apparatus.

7. The modified USB apparatus plug-in connector as claimed in claim 4, the converter means being chosen such that based on the properties of the cable and of the receiving apparatus they decide whether a conversion of the electrical USB 3 signals into optical USB signals is to take place.

8. The modified USB apparatus plug-in connector as claimed in claim 1, the means being designed such that they decide based on the electrical properties of the connected cable and of the receiving apparatus whether the USB 3 signals appear as electrical signals or optical signals at the output of the apparatus plug.

9. A hybrid socket for connection to an apparatus to convert the signals delivered by the apparatus, especially USB 3 signals, into optical signals which represent the USB 3 signals for transmission via a cable which allows optical transmission to a second apparatus or receiving apparatus which is able to receive optical USB 3 signals or has a hybrid socket which receives the optical signals and converts them into electrical USB 3 signals.

10. The hybrid socket as claimed in claim 9, the socket having a controller/transceiver which is able on the one hand to convert electrical USB 3 signals into optical USB 3 signals and which on the other hand is able to convert received optical USB 3 signals into electrical USB 3 signals.

11. The hybrid socket as claimed in claim 10, the controller/transceiver having a controller segment and a transceiver segment, in the controller segment switches being contained which triggered by controller and transceiver operational equipment are controlled depending on whether electrical USB 3 signals coming from the apparatus are to be converted into optical USB 3 signals and whether optical USB 3 signals transmitted via the cable are to be converted into electrical USB 3 signals.

12. The hybrid socket as claimed in claim 10, the transceiver segment having two converters, especially one electrooptical converter and one optoelectronic converter.

13. The hybrid socket as claimed in claim 10, in addition to the USB 3 signal transmission the socket also providing for electrical USB 2 signal transmission.

14. An active hybrid socket for electrical and optical USB connections, which can be plugged to normal USB 3 cables, but a “link-aware chip” being present in the socket which switches between electrical and optical connection.

15. The active hybrid socket as claimed in claim 14, miniaturized optoelectronic transceivers being installed in the USB socket.

16. The active hybrid socket as claimed in claim 15, the transceiver having driver and receiver ICs which are able to ascertain whether a USB cable is connected, and especially with a hybrid socket on the other end of the cable, when this is the case the transmission being carried out optically, conversely otherwise the IC operating on its “repeater” of the electrical USB signal.
